(19) United States
(12) Patent Application Publication
(10) Pub. No.: US 2024/0074341 A1
(43) Pub. Date: Mar. 7, 2024

(54) AUTOMATED GUIDED SCHEDULE AGRICULTURE SPRAYING MACHINE

(71) Applicants: Jolly Masih, Haryana (IN); Harvinder Singh, Woolloongabba (AU); Yasmeen Siddiqui, Selangor (MY); Ashish Sharma, New Brunswick, NJ (US); Vaidehi Sharma, Newark, CA (US); Gautami Sharma, New Brunswick, NJ (US); Chahat Masih, Sydney (AU); Ramesh Chandra Panda, Odisha (IN)

(72) Inventors: Jolly Masih, Haryana (IN); Harvinder Singh, Woolloongabba (AU); Yasmeen Siddiqui, Selangor (MY); Ashish Sharma, New Brunswick, NJ (US); Vaidehi Sharma, Newark, CA (US); Gautami Sharma, New Brunswick, NJ (US); Chahat Masih, Sydney (AU); Ramesh Chandra Panda, Odisha (IN)

(73) Assignees: Jolly Masih, Haryana (IN); Harvinder Singh, Woolloongabba (AU); Yasmeen Siddiqui, Selangor (MY); Ashish Sharma, New Brunswick, NJ (US); Vaidehi Sharma, Newark, CA (US); Gautami Sharma, New Brunswick, NJ (US); Chahat Masih, Sydney (AU); Ramesh Chandra Panda, Odisha (IN)

(21) Appl. No.: 18/504,924

(22) Filed: Nov. 8, 2023

(51) Int. Cl. A01B 69/00; G05D 1/02

(52) U.S. Cl. CPC A01B 69/004; A01B 69/001; G05D 1/0278; G05D 2201/0201

(57) ABSTRACT

Aspects of present disclosure relate to an automated guided schedule agriculture spraying machine. The automated guided schedule agriculture spraying machine comprises of a plurality of navigation sensors for navigation of the machine; a plurality of vision sensors for path detection; a navigation module to determine location; a plurality of wheel differential drive units to drive the machine; a processor for controlling operation; and a sprayer module for spraying chemicals on plants. It is an automated guided schedule agriculture spraying machine having RTK-DGPS navigation system useful for performing precise and efficient spraying of chemicals. In addition to forward/rear travel, the machine is able to operate in traverse, sidling and spin-turn travel. Both travel and elevation are electrically operated and completely oil-free, avoiding oil spill contamination of the floor surface.

### FIELD OF INVENTION

The present disclosure relates to automatic agricultural equipment, and particularly relates to an automated guided schedule agriculture spraying machine.

### BACKGROUND

Background description includes information that may be useful in understanding the present invention. It is not an admission that any of the information provided herein is prior art or relevant to the presently claimed invention, or that any publication specifically or implicitly referenced is prior art.

For several years, robotic systems have been used for industrial production and in warehouses, wherever controlled surroundings are often secured. A combined application of novel sensor systems, communication technologies, geographical information systems (GIS) and global positioning systems (GPS) have enabled researchers to develop new autonomous machines. Advances in different technologies, such as global navigation satellite systems, geographic information systems, high-resolution vision systems, innovative sensors and embedded computing systems, are finding direct application in agriculture.

Automated guidance control aims to steer the machine following the desired path automatically. It requires a guidance system to be able to detect machine posture, create a proper steering signal and steer the machine according to the signal. The posture is named as the position and orientation of the machine. Different guidance sensing systems have been developed for agricultural equipment in the past.

Norremark et al. development and assessment of the accuracy of an autonomous GPS-based system for intra-row mechanical weed control in row crops. The unmanned hoe was composed of an autonomous vehicle and a cycloid hoe. The vehicle and the tool were controlled independently to follow a pre-planned task. However, both of the subsystems had their own GNSSs, and therefore expensive components in the system were duplicated (M. Norremark, H. W. Griepentrog, J. Nielsen, H. T. Søgaard, Biosystems Engineering, Volume 101, Issue 4, 2008, Pages 396-410, ISSN 1537-5110, https://doi.org/10.1016/j.biosystemseng.2008.09.007).

Berge et al presented a GPS guided autonomous robot for weed control in cereals based on machine vision, a system able of perform weed monitoring and spraying in the same operation (T. W. Berge, S. Goldberg, K. Kaspersen, J. Netland, Volume 81, 2012, Pages 79-86, ISSN 0168-1699, https://doi.org/10.1016/j.compag.2011.11.004). Improvement in the integration of individual components is essential to establish fully autonomous agricultural system

Hence, there is a need to further develop an automated guided agriculture machine useful for performing precise and efficient spraying of chemicals. There is a need to simplify systems and to develop integrated fully autonomous agricultural equipment. Therefore, the present disclosure provides an automated guided schedule agriculture spraying machine.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### OBJECTS OF THE INVENTION

It is an object of the present disclosure which provides an automated guided schedule agriculture spraying machine.

It is an object of the present disclosure which provides an automated guided schedule agriculture spraying machine having RTK-DGPS navigation system useful for performing precise and efficient spraying of chemicals.

### SUMMARY

The present disclosure is directed towards an automated guided schedule agriculture spraying machine comprising of a plurality of navigation sensors for navigation of the machine; a plurality of vision sensors for path detection; a navigation module to determine location; a plurality of wheel differential drive units to drive the machine; a processor for controlling operation and a sprayer module for spraying chemicals on plants.

In an aspect of the present disclosure, the plurality of navigation sensors includes proximity sensors, infrared sensors and gyroscope sensors.

In an aspect of the present disclosure, the plurality of vision sensors includes camera.

In an aspect of the present disclosure, the navigation module is a real-time kinematic global positioning system (RTK-DGPS) based navigation.

In an aspect of the present disclosure, the plurality of wheel differential drive units is capable of driving the machine in forward/rear travel, traverse travel and spin-turn.

In an aspect of the present disclosure, the processor is configured with settings to operate the machine.

In an aspect of the present disclosure, the processor controls the machine using machine learning technology.

One should appreciate that although the present disclosure has been explained with respect to a defined set of functional modules, any other module or set of modules can be added/deleted/modified/combined and any such changes in architecture/construction of the proposed system are completely within the scope of the present disclosure. Each module can also be fragmented into one or more functional sub-modules, all of which also completely within the scope of the present disclosure.

Various objects, features, aspects and advantages of the inventive subject matter will become more apparent from the following detailed description of preferred embodiments in which like numerals represent like components.

### BRIEF DESCRIPTION OF THE DRAWING

The accompanying drawing is included to provide a further understanding of the present disclosure and is incorporated in and constitute a part of this specification. The drawing illustrates exemplary embodiments of the present disclosure and, together with the description, serve to explain the principles of the present disclosure.

FIG. 1 illustrates a Block diagram of automated guided schedule agriculture spraying machine (100) in accordance with embodiments of the present disclosure.

### DETAILED DESCRIPTION

Aspects of the present disclosure relate to an automated guided schedule agriculture spraying machine.

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

If the specification states a component or feature “may”, “can”, “could”, or “might” be included or have a characteristic, that particular component or feature is not required to be included or have the characteristic. Various terms as used herein are shown below. To the extent a term used in a claim is not defined below, it should be given the broadest definition persons in the pertinent art have given that term as reflected in printed publications and issued patents at the time of filing.

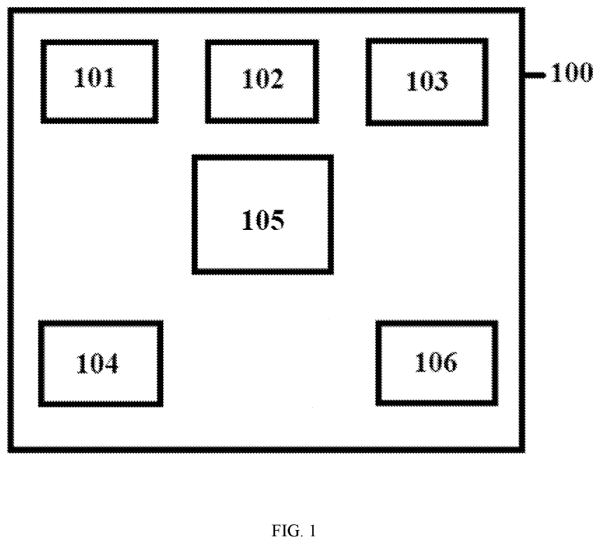

In an embodiment of the present disclosure, FIG. 1 discloses an automated guided schedule agriculture spraying machine (100). The automated guided schedule agriculture spraying machine (100) comprises of a plurality of navigation sensors (101) for navigation of the machine (100); a plurality of vision sensors (102) for path detection; a navigation module (103) to determine location; a plurality of wheel differential drive units (104) to drive the machine (100); a processor (105) for controlling operation; and a sprayer module (106) for spraying chemicals on plants.

The developed automated guided schedule agriculture spraying machine (100) is guided by different sensor-based and vision-based technology having RTK-DGPS navigation system. The machine (100) is useful for performing several agricultural operations such as tilling, spraying of pesticides, granular fertilizer application. The automated guidance control aims to steer the machine following the desired path automatically. The machine (100) is electrically operated having a power source such as battery.

In an embodiment of the present disclosure, the plurality of navigation sensors (101) are arranged on the body of the machine (100). The plurality of navigation sensors (101) includes proximity sensors, infrared sensors and gyroscope sensors. These plurality of navigation sensors (101) detect the proximity of any object while moving. The plurality of vision sensors (102) are also arranged on the body. The plurality of vision sensors (102) includes camera. The camera captures images while the machine is moving.

The plurality of navigation sensors (101) are used for sensing the plant or rows. These sensors are used as input devices in which sensors sense the plant or row and send commands to the processor (105) for signal processing and create output for agricultural operation. The images from camera are processed by the processor (105) to get a clear view for navigation of the machine (100).

The navigation module (103) is a real-time kinematic global positioning system (RTK-DGPS) based navigation. The RTK GPS is employed for precise positioning. The gyroscope sensors are used for measuring direction. The gyroscope sensors also maintain machine inclination. The machine (100) uses a computer vision technique to automate the process of navigation. To maintain the course of action, the machine (100) follows the rows of the crop in the field through an image processing algorithm. In this algorithm, the binary image was first split into several horizontal strips and then with the help of the vertical projection method, row position was estimated and finally detected the rows by using Hough transformation.

The processor (105) operably coupled to the body of the machine (100) is configured to automatically control the movement of the machine (100). The processor (105) is configured with settings to operate the machine (100). The processor (105) receives input from the plurality of navigation sensors (101), the plurality of vision sensors (102) and the navigation module (103). The processor (105) based on the inputs, controls the machine (100) using machine learning technology. Genetic algorithm (GA) is used as computational method for the development of automated guided vehicle or machine (100).

The processor (105) sends output to the actuators. The actuators are used to control movement of the plurality of wheel differential drive units (104). The plurality of wheel differential drive units (104) is positioned on the machine (100). The wheel differential drive units (104) are capable of driving the machine (100) in multiple modes like forward/rear travel, traverse travel and spin-turn. It can turn in a small radius. Both travel and elevation are electrically operated and completely oil-free, avoiding oil spill contamination of the floor surface.

The machine (100) is automatically controlled by the processor (105). The processor (105) sends output to move the machine (100) in desired direction. The machine (100) reaches the target location and perform agricultural task such as spraying pesticide as per pre-set instructions. The instructions can be pre-set in the processor as per the requirements. The machine (100) can automatically disperse chemicals on the plants using the sprayer module (106). The sprayer module comprises of a spraying nozzle. Spraying nozzle sprays the chemical using in built pump. A compartment for keeping chemicals is provided in the body of the machine (100).

Advantages of the Automated Guided Schedule Agriculture Spraying Machine (100) Using Transform Technique—
It has precise operation.
It can work continuously and automatically.
It is simple to operate and easy to maintain.
It provides improved reliability.
It provides faster and efficient operations.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

Thus, the scope of the present disclosure is defined by the appended claims and includes both combinations and sub-combinations of the various features described hereinabove as well as variations and modifications thereof, which would occur to persons skilled in the art upon reading the foregoing description.

1. An automated guided schedule agriculture spraying machine comprising of a plurality of navigation sensors for navigation of the machine;
a plurality of vision sensors for path detection;
a navigation module to determine location;
a plurality of wheel differential drive units to drive the machine;
a processor for controlling operation; and
a sprayer module for spraying chemicals on plants.

2. The automated guided schedule agriculture spraying machine as claimed in claim 1, wherein the plurality of navigation sensors includes proximity sensors, infrared sensors and gyroscope sensors.

3. The automated guided schedule agriculture spraying machine as claimed in claim 1, wherein the plurality of vision sensors includes camera.

4. The automated guided schedule agriculture spraying machine as claimed in claim 1, wherein the navigation module is a real-time kinematic global positioning system (RTK-DGPS) based navigation.

5. The automated guided schedule agriculture spraying machine as claimed in claim 1, wherein the plurality of wheel differential drive units is capable of driving the machine in forward/rear travel, traverse travel and spin-turn.

6. The automated guided schedule agriculture spraying machine as claimed in claim 1, wherein the processor is configured with settings to operate the machine.

7. The automated guided schedule agriculture spraying machine as claimed in claim 1, wherein the processor controls the machine using machine learning technology.
